(19) United States
(12) Patent Application Publication
(10) Pub. No.: US 2020/0349591 A1
(43) Pub. Date: Nov. 5, 2020

(54) COGNITIVE GO-TO-MARKET PRIORITIZATION SETS

(71) Applicant: International Business Machines Corporation, Armonk, NY (US)

(72) Inventors: Pritpal Arora, Bangalore (IN); Gopal S. Pingali, Bangalore (IN); SaiPrasad Kolluri Venkata Sesha, Bengaluru (IN); Bijo Kappen, Bangalore (IN)

(21) Appl. No.: 16/401,803

(22) Filed: May 2, 2019

(51) Int. Cl. G06Q 30/02; G06Q 10/06

(52) U.S. Cl. CPC G06Q 30/0201; G06Q 10/0637; G06Q 30/0206; G06Q 30/0203

(57) ABSTRACT

An approach is provided in which an information handling system collects a set of data corresponding to a new product development from multiple data sources. The set of data includes a set of industry data, a set product data, and a set of market data. Next, the information handling system performs contextual analysis on the set of industry data and generates a set of industry framework mappings that map the set of industry data to the set of product data. Then, the information handling system prioritizes a set of product features in the set of product data based on the set of industry framework mappings, and generates a prospective product solution set that corresponds to the new product development and includes the prioritized set of product features.

### BACKGROUND

Product development is a process by which new products are brought to market. Product development requires an understanding of customer needs and wants, the competitive environment, and the nature of the market. Cost, time, and quality are typically the main variables that drive customer needs. Focused on these three variables, innovative companies develop continuous practices and strategies to better satisfy customer requirements and to increase their own market share by a regular development of new products.

Time to market (TTM) is the length of time it takes from product conception until the product is available for sale. TTM is especially important in industries where products are quickly out dated. A common assumption is that TTM matters most for first-of-a-kind products, but the market leader often has the luxury of time compared to its followers. It is not uncommon for companies to find that the market has shifted, or new/unexpected competition has emerged, after a long requirements gathering phase, design phase, and development phase of creating a new product.

As defined herein, product data is data pertaining to a specific need of the product, business values, classification, pricing, modes of deployments, security principles, stakeholders' requirements, and etcetera. Industry data is data pertaining to the classification and alignment of a product to its specific industry segment and provides an industrial set of requirements for the product in consideration. Product features are enhancements, priorities, stakeholder requirements, and etcetera of a product. Market data is data pertaining to market insights related to the product features, success criteria, geo and market segmentation, risks, and etcetera.

### BRIEF SUMMARY

According to one embodiment of the present disclosure, an approach is provided in which an information handling system collects a set of data corresponding to a new product development from multiple data sources. The set of data includes a set of industry data, a set product data, and a set of market data. Next, the information handling system performs contextual analysis on the set of industry data and generates a set of industry framework mappings that map the set of industry data to the set of product data. Then, the information handling system prioritizes a set of product features in the set of product data based on the set of industry framework mappings, and generates a prospective product solution set that corresponds to the new product development and includes the prioritized set of product features.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

According to an aspect of the present invention there is a method, system and/or computer program product that performs the following operations (not necessarily in the following order): (i) collecting a set of data from a plurality of data sources that correspond to a new product development, wherein the set of data comprises a set of industry data, a set product data, and a set of market data; (ii) generating a set of industry framework mappings that map the set of industry data to the set of product data based on analyzing the set of industry data against the set of product data; (iii) prioritizing a set of product features in the set of product data based on the set of industry framework mappings; and (iv) generating a prospective product solution set that corresponds to the new product development and includes the prioritized set of product features.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is an exemplary diagram depicting a cognitive market solution system that evaluates product requirements against market requirements to generate a prospective product solution set;

FIG. 4 is an exemplary diagram depicting a prospective product solution set;

FIG. 5 is an exemplary diagram depicting details of a cognitive requirements analyzer;

FIG. 6 is an exemplary flowchart showing steps taken to generate product vision statements;

FIG. 7 is an exemplary flowchart showing steps taken by a minimum viable product analyzer to add minimum viable product solutions to a prospective product solution set; and

FIG. 8 is an exemplary diagram depicting details of cognitive requirements analyzer.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

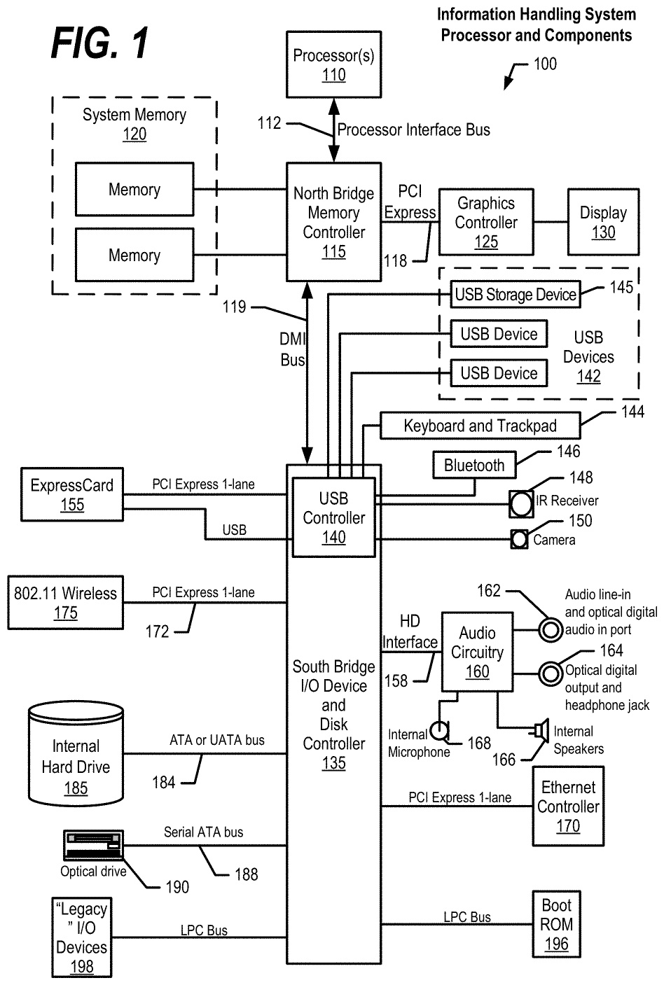

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, Peripheral Component Interconnect (PCI) Express bus 118 connects Northbridge 115 to graphics controller 125. Graphics controller 125 connects to display device 130, such as a computer monitor.

Northbridge 115 and Southbridge 135 connect to each other using bus 119. In some embodiments, the bus is a Direct Media Interface (DMI) bus that transfers data at high speeds in each direction between Northbridge 115 and Southbridge 135. In some embodiments, a PCI bus connects the Northbridge and the Southbridge. Southbridge 135, also known as the Input/Output (I/O) Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and Universal Serial Bus (USB) connectivity as it connects to Southbridge 135 using both the USB and the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, Integrated Services Digital Network (ISDN) connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the Institute of Electrical and Electronic Engineers (IEEE) 802.11 standards of over-the-air modulation techniques that all use the same protocol to wireless communicate between information handling system 100 and another computer system or device. Optical storage device 190 connects to Southbridge 135 using Serial Analog Telephone Adapter (ATA) (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality associated with audio hardware such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, Automated Teller Machine (ATM), a portable telephone device, a communication device or other devices that include a processor and memory.

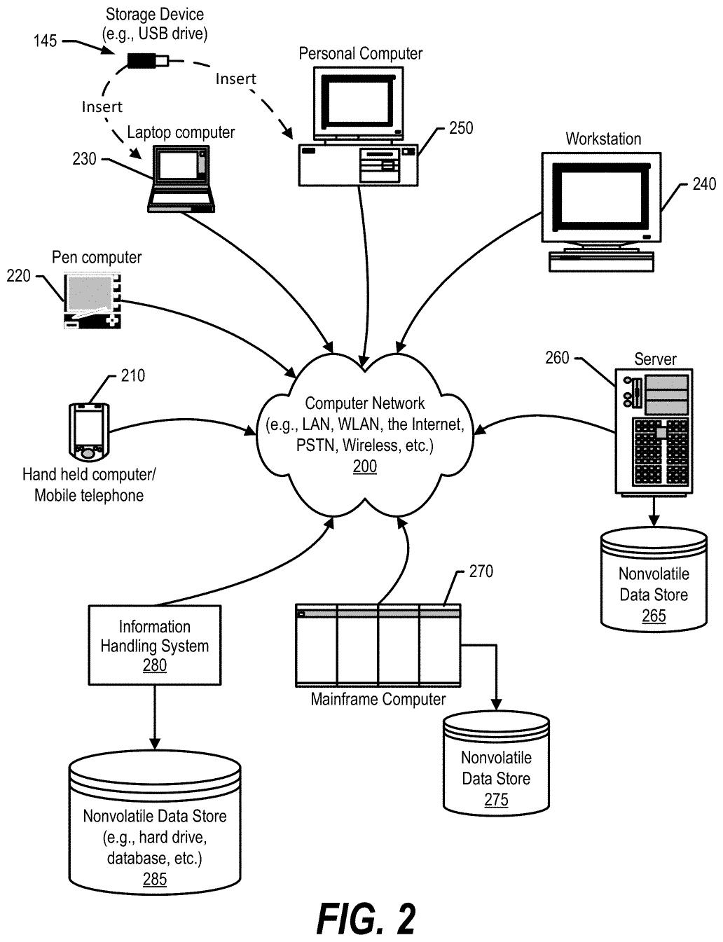

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as Moving Picture Experts Group Layer-3 Audio (MP3) players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. The embodiment of the information handling system shown in FIG. 2 includes separate nonvolatile data stores (more specifically, server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

As discussed above, time to market is an important aspect of successful product development. Today's product development approaches include workshops and meetings to freeze product requirements; manual modes of market survey and insights to product development teams; and internal testing cycles and defect tracking mechanisms for newer releases. Unfortunately, a lack of synergy between internal development and marketing teams exists to decide and conclude on product features. Product managers are typically unable to pinpoint key features that could be the “WOW” factors that differentiate their products from competitors and hence be unable to decide on a minimal viable product (MVP). As defined herein, a minimum viable product is a product with a correct amount of features to satisfy early customers and to provide feedback for future product development.

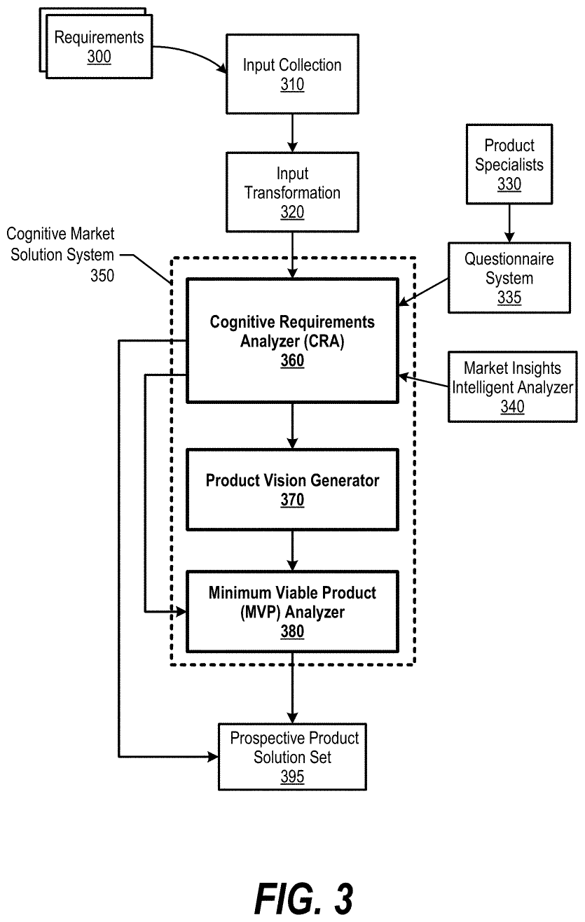

FIGS. 3 through 7 depict an approach that can be implemented on an information handling system that cognitively and intelligently maps market insights to recommended product features. The approach dynamically generates a prioritized list of solution requirements derived from external market insights, internal features propositions, and enterprise standard requirements. The approach then cognitively and dynamically generates scenarios for a minimum viable product and prototype/mockup release mapped to the prioritized list of functional requirements based on their derived market impacts. In addition, the approach builds a self-intelligent library of product features built on learning from various historical sets of similar product requirements from various industry segments such as retail, finance, and etcetera. The approach also dynamically builds a vision plan that aligns to a design thinking framework and generates staggered release plans that correlate product features to market intelligence.

As defined herein, an industry framework mapping maps product features to industry requirements. The following are examples of industry framework mappings:

| PRODUCT FEATURES | | INDUSTRY REQUIREMENTS |
|---|---|---|
| Product: Multi-cloud | <-> | Multi-cloud platform with fault |
| platform | | tolerance, rapidly scalable, server- |
| | | less, containerized with scale-out |
| | | capabilities tuned as per application |
| | | consumption demand. |
| Product: Home-appliances | <-> | Server-less, connected metrics |
| enabled IOT (Internet of | | system with usage-metrics, encrypted |
| Things) system | | secure protocols. |

As defined herein, a market intelligence mapping maps product features to market data. The following are examples of market intelligence mappings:

| PRODUCT FEATURES | | MAREKT DATA |
|---|---|---|
| Product: Multi-cloud | <-> | Multi-cloud IAAS, PAAS services, |
| platform | | consumable via standardized Identity |
| | | and access management system with |
| | | distributed workloads spread across |
| | | multiple cloud services. |
| Product: Home-appliances | <-> | Multilingual system, electrical and |
| enabled IOT (Internet of | | motor devices, electronic systems, |
| Things) system | | diverse set of appliance, user-aware |
| | | and personalized for each user, |
| | | personalization via remote devices. |

FIG. 3 is an exemplary diagram depicting a cognitive market solution system that evaluates product requirements against market requirements to generate a prospective product solution set. As discussed herein, cognitive market solution system 350 performs an amalgamation of multiple sources of internal and external requirements to derive a prospective product solution set of requirements. Cognitive market solution system 350 also performs data reconciliation and aggregation from multiple structured and unstructured data sources consolidated and originating from product feature lists, external market surveys, internal defects, compliance requirements, competitive product features, pricing, and etcetera. In addition, cognitive market solution system 350 performs information aggregation and mapping with structured and columnar data retrieved and compared to build a master aggregated data. Cognitive market solution system 350 performs relationship extraction, semantic analysis, keyword mappings and contextual analysis with associations on the master aggregated data. In addition, cognitive market solution system 350 performs groupings based on similar problem areas and industry type, segmentations on the groupings based on the problem type within a given area and industry, and classifications on the segmented groupings based on product features for given problem types of various functional and non-functional requirements. The classified segmented groupings help finalize prioritized requirements which in turn help in generating product vision statements.

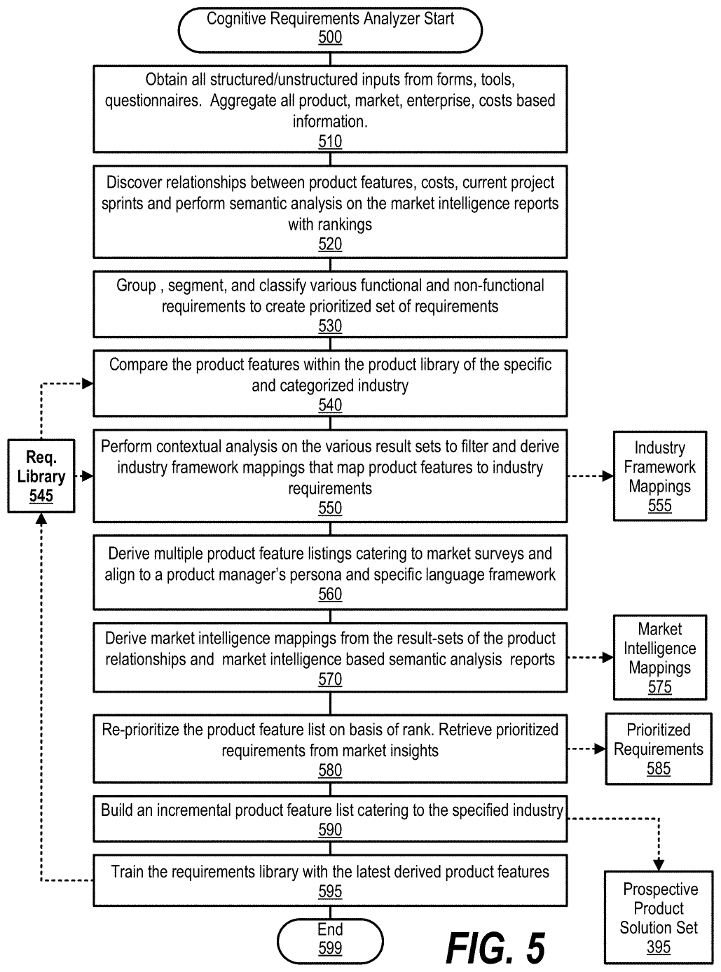

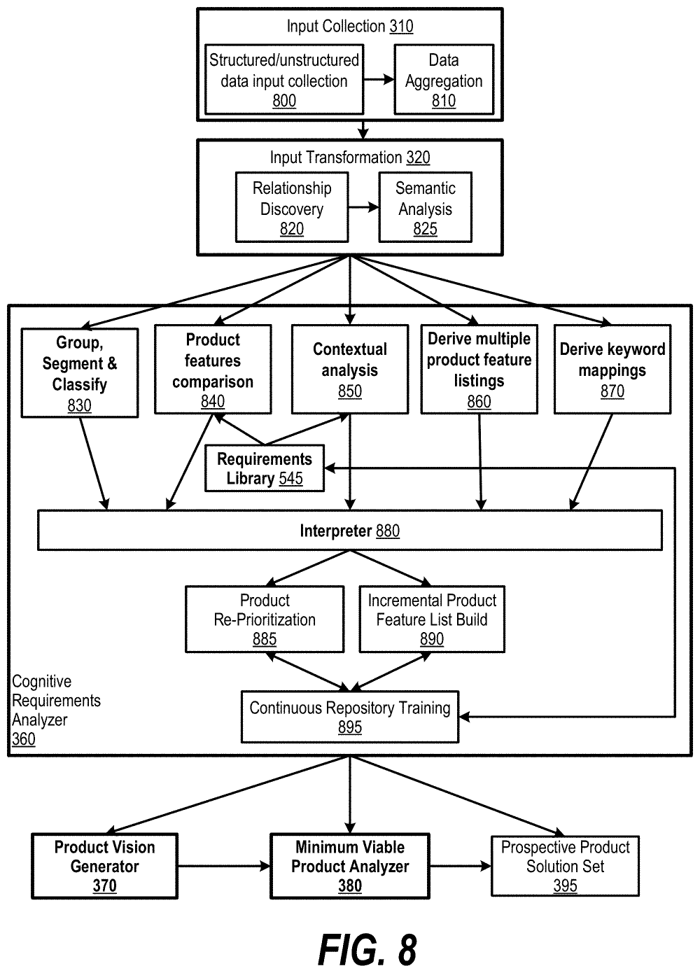

Cognitive market solution system 350 collects requirements 300 via input collection 310. Requirements 300, in one embodiment, are a collection of structured resources and unstructured resources. Input collection 310 aggregates requirements 300 and feeds them to input transformation 320. Input transformation 320 performs relationship discovery and semantic analysis on the aggregate requirements, and feeds the transformed requirements to cognitive requirements analyzer 360 (see FIGS. 5, 8, and corresponding text for further details).

In one embodiment, cognitive requirements analyzer 360 uses an interactive questionnaire system 335 such as web forms, questionnaires, question and answer tools, etc. to collect information from product specialists 330. Cognitive requirements analyzer 360 then performs groupings, segmentations, and classifications of various functional and non-functional requirements and generates a prioritized list of mapped requirements based on external market insights (market insights intelligent analyzer 340), internal feature propositions, and enterprise standard requirements (from input transformation 320).

Cognitive requirements analyzer 360 also generates a prioritized list of defects to be resolved based on the market intelligence (web forms, questionnaires, question and answer tools, etc.) and performs classification and propagation of various requirements to various target developer groups. In addition, cognitive requirements analyzer 360 builds a self-intelligent feature library based on learning from various historical sets of similar product requirements from various industry segments as retail, finance, etc. (see FIG. 5 and corresponding text for further details).

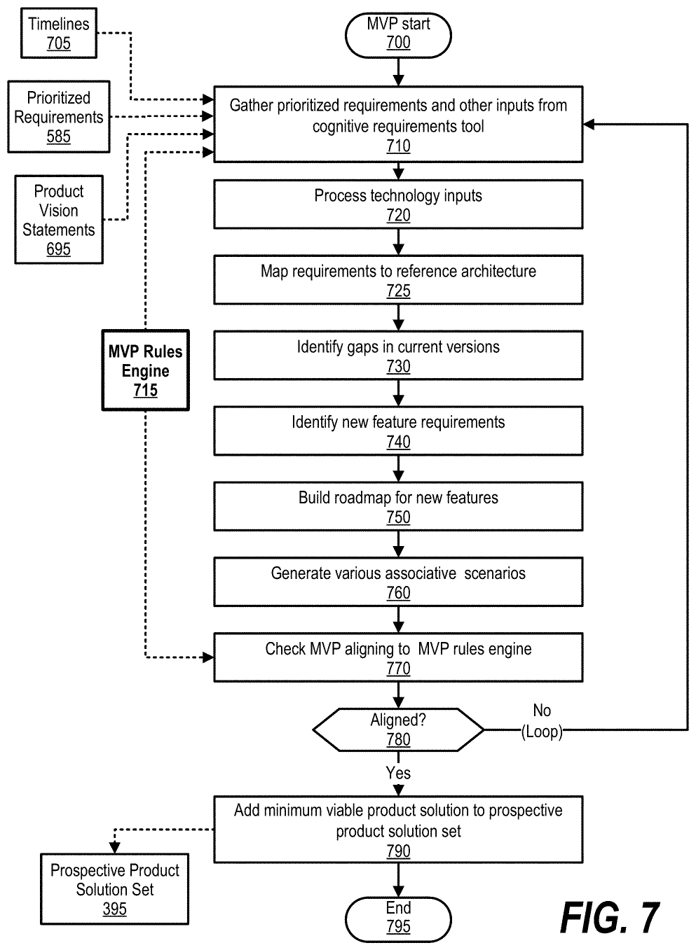

Product vision generator 370 receives the prioritized lists from cognitive requirements analyzer 360 and performs various steps to generate product vision statements based on WHO-WHAT-WOW mappings, which are fed into minimum viable product analyzer 380. Minimum viable product analyzer 380 dynamically extends the product features from the prioritized list to suggest MVP (minimum viable product) scenarios. Minimum viable product analyzer 380 generates multiple scenarios on the basis of the requirements, further suggesting phases of development and go-to-market. In addition, minimum viable product analyzer 380 generates staggered release plans for the product that correlate product features to the market intelligence and adjusts prospective product solution set 395 accordingly (see FIG. 7 and corresponding text for further details).

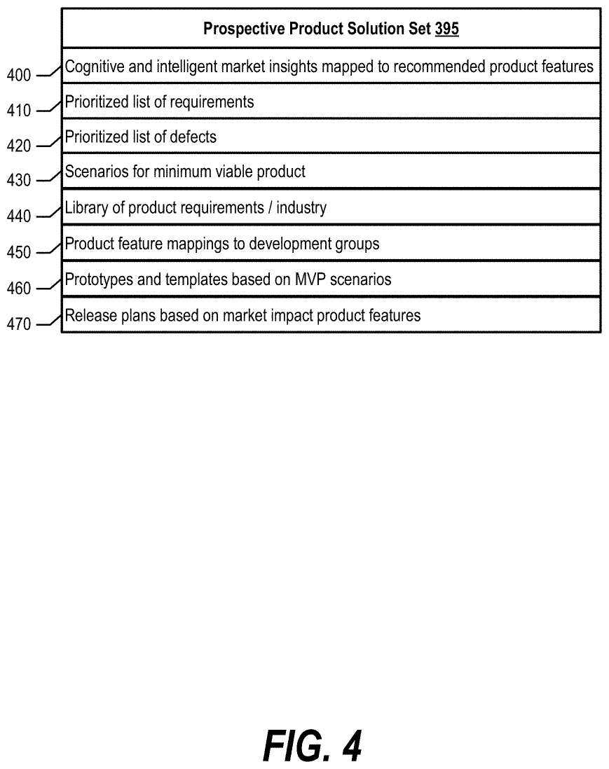

FIG. 4 is an exemplary diagram depicting a prospective product solution set. A prospective product solution set as defined herein includes one or more of sections 400 through 470 to assist a product development group in creating a viable and successful product solution. Section 400 includes cognitive and intelligent market insights mapped to recommended product features. For example, when a business has a proposal for a new loan product for the rural market, Section 400 includes (i) a flexible loan return on investment (ROI) and tenures based on salary and income; (ii) kiosk based loan disbursement for small loans; and (iii) mortgage rules dilution for known references.

Section 410 includes a prioritized list of requirements. Using the example above, section 410 includes (i) kiosks, (ii) loan tenure flexibility, and (iii) reduced collaterals. Section 420 includes a prioritized list of defects, such as (i) Kiosk integration with payment channel is not secure (P1); (ii) kiosk GUI alignment is improper (P3); (iii) loan dates are not in the correct format (P3); (iv) access point to the kiosk is not secure (P1); (v) logout functionality is non-functional (P2); and (vi) non-privileged users can still see ‘Admin’ functions (P1).

Section 430 includes scenarios for a minimum viable product, such as a proposed new loan for rural markets with features such as (i) flexible loans and tenures based on salary and income; (ii) kiosk based loan disbursements for loans less than ‘$10,000’; and (iii) mortgage rules engine for marginalized segments. Section 440 includes a library of product requirements and industry requirements, such as reference architectures, loan & financial instruments from major providers, collateral definitions, loan product manuals, etc.

Section 450 includes a product feature mappings to development groups. Using the example above, section 450 may include trending industry recommended features such as loan tenure flexibility and education loans with zero collaterals. Section 460 includes prototypes and templates based on MVP scenarios. Using the example above, section 460 may include “MVP 1: Education loans up to $ X for income group $Y; MVP 2: Education loans for income group $Z with collateral release of $ S.”

Section 470 includes release plans based on market impact product features. Using the example above, section 470 may include “Release Education loans with zero collateral in Z district at the end of summer season.”

FIG. 5 is an exemplary flowchart showing steps taken by cognitive requirements analyzer 360 to generate an initial prospective product solution set. Processing commences at 500, whereupon, at step 510, the process collects data from various sources as discussed herein and aggregates the data, such as aggregation of all product data, market data, enterprise data, and cost data. The aggregated data then feeds into input transformation 320.

At step 520, the process discovers the relationships between the product features and requirements, associated costs, current project sprints, specific enterprise requirements, etc. The process also performs semantic analysis to identify keyword mappings between the various proposed product features as well as the market intelligence reports.

At step 530, the process groups, segments, and classifies the various functional and non-functional requirements from market data and product features to create a prioritized set of requirements. At step 540, the process compares the product features within requirements library 545 of the specific categorized industry. At step 550, the process performs contextual analysis on the result sets based on the industry, problem area and the problem type as done in 530 and 540 to derive industry framework mappings 555 from the product features and industrial product libraries.

At step 560, the process derives multiple product feature listings catering to market surveys and aligning to a product manager's persona and specific language framework. At step 570, the process derives market intelligence mappings 575 from the result-sets of the product relationships and market intelligence based semantic analysis reports.

At step 580, the process reprioritizes the product feature list based on rank (prioritized requirements 585) and retrieves prioritized requirements from market insights intelligent analyzer 340. At step 590, the process builds an incremental product feature list based on a differential delta existing between the existing set of the product features as well as the re-prioritized feature list, and includes it in prospective product solution set 395 (see FIG. 4 and corresponding text for further details). At step 595, the process updates requirements library 545 by providing continuous feedback on the various product features, associations to market insights, enterprise specific feature requirements, product preferences from industry library, various associations, and contexts, etc. FIG. 5 processing thereafter ends at 599.

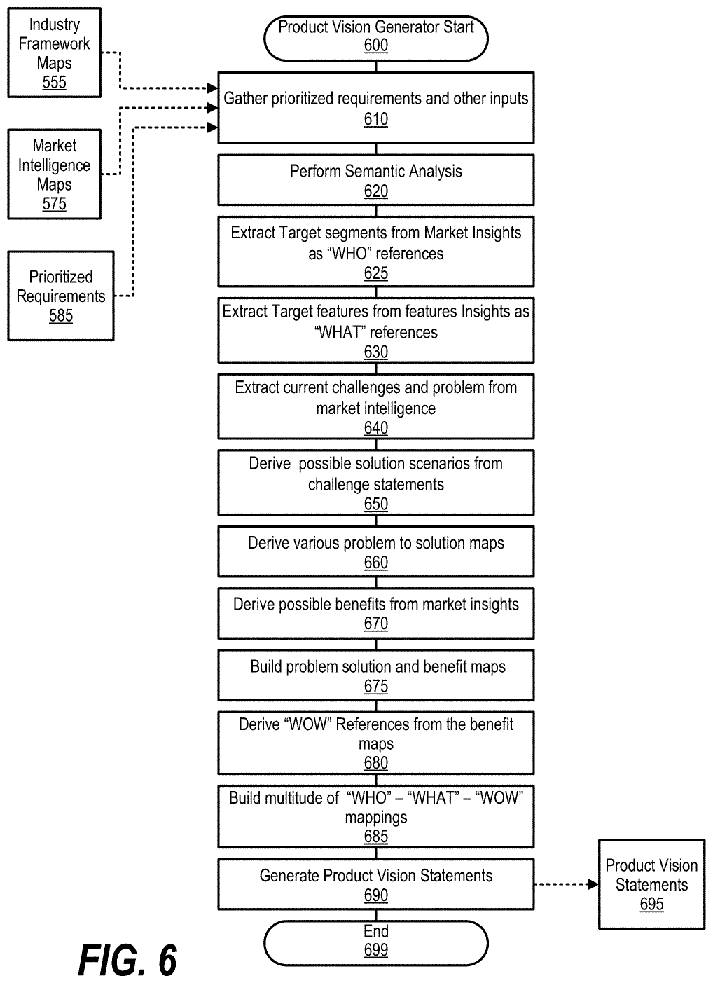

FIG. 6 is an exemplary flowchart showing steps taken to generate product vision statements. FIG. 6 processing commences at 600 whereupon, at step 610, the process gathers industry framework maps 555, market intelligence maps 575, and prioritized requirements 585 rom cognitive requirements analyzer 360. At step 620, the process performs semantic analysis to build upon the annotation of the keyword association between various personas (WHO), product features (WHAT) and product differentiator benefits (WOW).

At step 625, the process extracts target segments from market insights as

“WHO” references, such as farmers, teachers, etc. In one embodiment, the market insights are from market intelligence reports. At step 630, the process extracts target features from features insights as “WHAT” references, such as a GUI design feature for a kiosk, loan tenure and ROI for a new proposed loan-based product targeted for a rural market, etc.

At step 640, the process extracts current challenges and problems from market intelligence, such as current loan repayment challenges by the farmers, higher mortgage collaterals for a new envisaged loan-based product targeted for a rural market, etc.

At step 650, the process derives possible solution scenarios from challenge statements. At step 660, the process derives various problem to solution maps. At step 670, the process derives possible benefits from market insights. At step 675, the process builds a problem solution and benefit map, such as proposing solution statements from the challenge statements in-line with the industry rules (e.g., provide loans with interest rates of 15%, trust criteria dilution with known references, extended mortgage durations, kiosks for loan disbursements, etc.). Possible benefits would be ease of loan availability, faster clearances by 20%, savings of 30% on interests, easier repayment schedules, etc.

At step 680, the process derives a “WOW” references from the benefit maps such as faster loan clearances, 30% reduced loan interests, etc. At step 685, the process builds a multitude of “WHO”-“WHAT”-“WOW” mappings, such as teachers to receive educational loans with zero collaterals and savings of 30% on interest rates, or farmers to obtain loans up to $30K per month with faster clearances up to 20%. At step 690, the process generates product vision statements 695 that are fed into minimum viable product analyzer 380 (see FIG. 7 and corresponding text for further details). FIG. 6 processing thereafter ends at 699.

FIG. 7 is an exemplary flowchart showing steps taken by minimum viable product analyzer 380 to add minimum viable product solutions to prospective product solution set 395. FIG. 7 processing commences at 700 whereupon, at step 710, the process gathers timelines 705 (e.g., product availability in six months), prioritized requirements 585, and product vision statements 695. At step 720, the process processes technology inputs such as product manuals, spreadsheets, current sets of requirements, market survey and insights, product defect lists, compliance requirements, etc.

At step 725, the process maps requirements to a reference architecture, such as a ‘Digital Banking Reference Architecture’. At step 730, the process identifies gaps in current versions, such as ‘enterprise security and compliance requirements’.

At step 740, the process identifies new feature requirements based on, for example, new API standards, new integration patterns to connect to the backend services, etc. At step 750, the process builds a roadmap for new features. At step 760, the process generates various associative scenarios. For example, the process generates a prioritized list of correlated features that enables the security compliance for the digital banking as new secure channels for integration, API taxonomy, etc. At step 770, the process checks whether the minimum viable product analysis aligns to MVP Rules engine 715. For example, MVP rules engine 710 may specify standards for a specific integration, compliance specifics which requires mandatorily adherence.

The process determines as to whether the minimum viable product analysis is aligned to MVP Rules engine 715 (decision 780). If not aligned, then decision 780 branches to the ‘no’ branch which loops back to gather and process more requirements. This looping continues until the minimum viable product analysis is aligned to MVP Rules engine 715, at which point decision 780 branches to the ‘yes’ branch exiting the loop. At step 790, the process adds minimum viable product solutions to prospective product solution set 395. FIG. 7 processing thereafter ends at 795.

FIG. 8 is an exemplary diagram depicting details of cognitive requirements analyzer 360. Input collection 310 uses two stages to collect data input. Structured/unstructured data input collection 800 collects data from various sources as discussed herein and aggregates the data via data aggregation 810. In one embodiment, aggregation of all product, market, enterprise, costs based information is performed. The aggregated data then feeds into input transformation 320.

Input transformation 320 performs relationship discovery 820, which discovers the relationships between the product features and requirements, associated costs, current project sprints, specific enterprise requirements, etc. Then, input transformation 320 performs semantic analysis 825 that performs keyword mappings between the various proposed product features as well as the market intelligence reports. The output of input transformation feeds into cognitive requirements analyzer 360.

Cognitive requirements analyzer 360 receives the data and performs steps 830 through 870. Group, segment, and classify 830 performs segmentation and classification to create a prioritized set of requirements based on similar problem areas and industry type, segmentations on the groupings based on the problem type within a given area and industry, and classifications on the segmented groupings based on product features for given problem types, of various functional and non-functional requirements. Product features comparison 840 compares the product features within requirements library 545 of the specific and categorized industry. Contextual analysis 850 annotates and maps result sets based on inputs collected, analyzed with semantic analysis mapped against the requirements library 545 to derive multiple contexts from the product features, industrial product libraries, and market insights. Derive multiple product feature listings 860 builds upon the result sets to produce a prioritized, ranked ordered list of product features to be implemented. Derive keyword mappings 870 produces a list of keywords as derived from the result sets of the product relationships and market intelligence based semantic analysis reports.

Interpreter 880 receives outputs from steps 830 through 870 and performs a translation to align to a product manager's persona while also aligning to his/her specific language framework. Cognitive requirements analyzer 360 then performs product re-prioritization 885 that is a basis of the ranked order as aligned to the market insights and specific preference as set by the product manager. Cognitive requirements analyzer 360 also builds an incremental product feature list 890 based on a differential delta existing between the existing set of the product features as well as the re-prioritized feature list. Continuous repository training 895 receives continuous feedback on the various product features, associations to the market-insights, enterprise specific feature requirements, product preferences from industry library, various associations and contexts, etc. and updates requirements library 545 accordingly.

Cognitive requirements analyzer 360 outputs prospective product solution set 95 (see FIG. 4 and corresponding text for further details). Cognitive requirements analyzer 360 also provides the prioritized requirements to production vision generator 370, which performs various steps to generate product vision statements based on WHO-WHAT-WOW mappings, which are fed into minimum viable product analyzer 380 (see FIG. 6 and corresponding text for further details).

Minimum viable product analyzer 380 utilizes the product vision statements, along with prioritized requirements from cognitive requirements analyzer 360, to generate staggered release plans for the product correlating the features to the market intelligence and adjust prospective product solution set 395 accordingly (see FIG. 7 and corresponding text for further details).

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

Some embodiments of the present invention may include one, or more, of the following features, characteristics, operations and/or advantages: (i) focused on building a prioritized list of requirements for a new go to market product; (ii) builds on cognitive self-learning capability of the system to generate library of product features built on learning from various historical set of similar product requirements from various industry segments as retail, finance, etc.; (iii) dynamically extend the product features from the prioritized list to suggest MVP scenarios; (iv) builds on cognitive self-learning capability of the system to generate library of product features built on learning from various historical set of similar product requirements from various industry segments as retail, finance, etc.; (v) additionally produces a defect prioritization list also mapping to market based intelligence delivers; (vi) builds upon the notion of prioritizing requirements and building scenarios for minimum viable product and release plans based on market insights; and/or (vii) relies on a cognitive engine to evolve on various products based features for various industries.

1. A method implemented by an information handling system that includes a memory and a processor, the method comprising:
collecting a set of data from a plurality of data sources that correspond to a new product development, wherein the set of data comprises a set of industry data, a set product data, and a set of market data;
generating a set of industry framework mappings that map the set of industry data to the set of product data based on analyzing the set of industry data against the set of product data;
prioritizing a set of product features included in the set of product data based on the set of industry framework mappings; and
generating a prospective product solution set that corresponds to the new product development and comprises the prioritized set of product features.

2. The method of claim 1 further comprising:
in response to performing semantic analysis on the set of product data and the set of market data, deriving a set of market intelligence mappings that map the set of product data to the set of market data;
reprioritizing the prioritized set of product features based on the set of market intelligence mappings; and
revising the prospective product solution set based on the reprioritized set of product features.

3. The method of claim 2 further comprising:
generating a minimum viable product solution based on evaluating the reprioritized set of product features against at least one go-to-market timeline.

4. The method of claim 3 further comprising:
generating one or more staggered release plans of one or more products corresponding the new product development, wherein at least one of the one or more staggered release plans corresponds to the minimum viable product solution.

5. The method of claim 1 further comprising:
organizing the set of data into a set of industry segments;
building a dynamic feature library based on the organized set of data in the set of industry segments; and
adjusting the dynamic feature library based on feedback selected from the group consisting of a new product enhancement, a new compliance requirement, a new market intelligence, a new product-market map association derivation, and a new product manager priority.

6. The method of claim 1 further comprising:
building a product vision statement based on the set of industry framework mappings and the prioritized set of product features, wherein the product vision statement comprises a set of personas, a set of features, and a set of benefits statements.

7. The method of claim 1 further comprising:
grouping a set of requirements comprising at least one functional requirement and at least one non-functional requirement based on a set of problem types and a set of industry types;
segmenting the set of grouped requirements based on one or more problem types within one of the set of industry types; and
classifying the segmented set of grouped requirements based on the set of product data and the set of product types, wherein the classified segmented set of grouped requirements are utilized during the generation of the set of industry framework mappings.

8. The method of claim 1 further comprising:
generating a prioritized list of defects based on the set of market data; and
distributing the prioritized list of defects to one or more corresponding target developer groups.

9. An information handling system comprising:
one or more processors;
a memory coupled to at least one of the processors;
a set of computer program instructions stored in the memory and executed by at least one of the processors in order to perform actions of:
collecting a set of data from a plurality of data sources that correspond to a new product development, wherein the set of data comprises a set of industry data, a set product data, and a set of market data;
generating a set of industry framework mappings that map the set of industry data to the set of product data based on analyzing the set of industry data against the set of product data;
prioritizing a set of product features included in the set of product data based on the set of industry framework mappings; and
generating a prospective product solution set that corresponds to the new product development and comprises the prioritized set of product features.

10. The information handling system of claim 9 wherein the processors perform additional actions comprising:
in response to performing semantic analysis on the set of product data and the set of market data, deriving a set of market insights mappings that map the set of product data to the set of market data;
reprioritizing the prioritized set of product features based on the set of market insights mappings; and
revising the prospective product solution set based on the reprioritized set of product features.

11. The information handling system of claim 10 wherein the processors perform additional actions comprising:
generating a minimum viable product solution based on evaluating the reprioritized set of product features against at least one go-to-market timeline; and
generating one or more staggered release plans of one or more products corresponding the new product development, wherein at least one of the one or more staggered release plans corresponds to the minimum viable product solution.

12. The information handling system of claim 9 wherein the processors perform additional actions comprising:
organizing the set of data into a set of industry segments;
building a dynamic feature library based on the organized set of data in the set of industry segments; and
adjusting the dynamic feature library based on feedback selected from the group consisting of a new product enhancement, a new compliance requirement, a new market intelligence, a new product-market map association derivation, and a new product manager priority.

13. The information handling system of claim 9 wherein the processors perform additional actions comprising:
building a product vision statement based on the set of industry framework mappings and the prioritized set of product features, wherein the product vision statement comprises a set of personas, a set of features, and a set of benefits statements.

14. The information handling system of claim 9 wherein the processors perform additional actions comprising:
grouping a set of requirements comprising at least one functional requirement and at least one non-functional requirement based on a set of problem types and a set of industry types;
segmenting the set of grouped requirements based on one or more problem types within one of the set of industry types; and
classifying the segmented set of grouped requirements based on the set of product data and the set of product types, wherein the classified segmented set of grouped requirements are utilized during the generation of the set of industry framework mappings.

15. The information handling system of claim 9 wherein the processors perform additional actions comprising:
generating a prioritized list of defects based on the set of market data; and
distributing the prioritized list of defects to one or more corresponding target developer groups.

16. A computer program product stored in a computer readable storage medium, comprising computer program code that, when executed by an information handling system, causes the information handling system to perform actions comprising:
collecting a set of data from a plurality of data sources that correspond to a new product development, wherein the set of data comprises a set of industry data, a set product data, and a set of market data;
generating a set of industry framework mappings that map the set of industry data to the set of product data based on analyzing the set of industry data against the set of product data;
prioritizing a set of product features included in the set of product data based on the set of industry framework mappings; and
generating a prospective product solution set that corresponds to the new product development and comprises the prioritized set of product features.

17. The computer program product of claim 16 wherein the information handling system performs further actions comprising:
in response to performing semantic analysis on the set of product data and the set of market data, deriving a set of market insights mappings that map the set of product data to the set of market data;
reprioritizing the prioritized set of product features based on the set of market insights mappings; and
revising the prospective product solution set based on the reprioritized set of product features.

18. The computer program product of claim 17 wherein the information handling system performs further actions comprising:
generating a minimum viable product solution based on evaluating the reprioritized set of product features against at least one go-to-market timeline; and
generating one or more staggered release plans of one or more products corresponding the new product development, wherein at least one of the one or more staggered release plans corresponds to the minimum viable product solution.

19. The computer program product of claim 16 wherein the information handling system performs further actions comprising:
organizing the set of data into a set of industry segments;
building a dynamic feature library based on the organized set of data in the set of industry segments; and
adjusting the dynamic feature library based on feedback selected from the group consisting of a new product enhancement, a new compliance requirement, a new market intelligence, a new product-market map association derivation, and a new product manager priority.

20. The computer program product of claim 16 wherein the information handling system performs further actions comprising:
grouping a set of requirements comprising at least one functional requirement and at least one non-functional requirement based on a set of problem types and a set of industry types;
segmenting the set of grouped requirements based on one or more problem types within one of the set of industry types; and
classifying the segmented set of grouped requirements based on the set of product data and the set of product types, wherein the classified segmented set of grouped requirements are utilized during the generation of the set of industry framework mappings.
